(19) United States
(12) Patent Application Publication
(10) Pub. No.: US 2009/0058125 A1
(43) Pub. Date: Mar. 5, 2009

(54) Automobile double rwos visor

(76) Inventor: Tony Mintung Mac, San Francisco, CA (US)

Correspondence Address: Tony Mintung Mac, 2674, 47th Avenue, San Francisco, CA, 94116, US

(21) Appl. No.: 11/897,946

(22) Filed: Sep. 4, 2007

(51) Int. Cl. B60J 3/02

(52) U.S. Cl. 296/97.2; 296/97.12; 296/97.9

(57) ABSTRACT

In daily driving one is constant bombarded with distractions. Falling victim to the blinding sunlight can be one, such outcome that can lead to a disastrous of car accident. My invention will provide drivers and passengers added security by adding a transparent light color visor to the original car visor thus shielding the user from unwanted light. this is accomplished by employing two visors, the first row which uses the transparent light color visor. the second row which is the existing factory visor. the two row of visors will use the existing mounting bracket along with a bracket adapter to mounted it the two rows visor may overlap each other and be used separately at various position to shield the eyes of the automobile driver and passenger.

### REFERENCES CITED

U.S. Pat. Documents

| | | |
|---|---|---|
| U.S. 4,690,450 | September 1987 | Boerema |
| U.S. 4,681,363 | July 1987 | Hemmeke |
| U.S. 4,666,205 | May 1987 | Nakagawa |
| U.S. 3,556,585 | January 1971 | |
| U.S. 3,472,549 | October 1969 | Wiesmann herbert |
| U.S. 2,823,950 | February 1958 | Harris |
| U.S. 2,681,824 | June 1954 | Knoblock |
| U.S. 2,261,881 | November 1941 | Gustav horstmann |
| U.S. 6,328,371 | December 2001 | Mac |
| U.S. 5,816,642 | October 1998 | Wilson |
| U.S. 5,533,776 | July 1996 | Agro |
| U.S. 4,821,374 | April 1989 | Gavagan |
| U.S. 3,201,170 | August 1965 | Abraham weingarten |

### BACKGROUND OF THE INVENTION

This invention relates to my original U.S. Pat. No. 6,328,371 B 1. vehicle sun visor. Because divisional personal drive custom demand and automobile manufacture after market sale convention. By adding another layer similar sized elongated light color transparency panel at the existing original automobile visors mounting bracket to make a double rows automobile visor. This light color panel permit the necessary variation in transparency required for day and night driving to shield the eyes of car operator or passenger from oncoming and sides of automobile headlights or sun rays. It is obvious that each panel can be used independently to permit adjustments to suit one's viewing needs.

### SUMMARY OF THE INVENTION

In accordance with the invention, the automobile has two rows of visor panels. the first row visor is an elongated light color transparency panel. the second row visor is the existing automobile visor panel. the colored transparency panel is then attached to a slotted spring sleeve adhering by epoxy glue. said panel is clamped at an up turn end of the visor support rod securely but yet permits said panel to be adjusted to suit viewing needs and mounted at the top of the existing original visor bracket. It is obvious that each visor panel can be used independently during day or night for driver and passenger to suit their viewing needs.

### BRIEF DESCRIPTION OF THE DRAWING

Further objects and advantages of the invention will become apparent from the following description and claims and from the accompanying drawing, wherein:

FIG. 1 is a perspective view of the automobile double rows visor of present invention.

FIG. 2 and FIG. 3 are front and side views of an improved light color transparency panel and the attached slotted spring sleeve adhered by epoxy glue.

FIG. 4 is a perspective view of the visor support rod.

FIG. 5 is a top view of automobile visor bracket adaptor.

FIG. 6 is a bottom view of automobile visor bracket adaptor.

FIG. 7 is a perspective view of automobile visor bracket adaptor open box's cover.

FIG. 8 are a combination view of automobile visor comprise bracket adaptor with open box, visor support rod with the compression spring.

FIG. 9 is a enlarged view for the combination of the automobile visor's bracket adaptor with open box, support rod with the compression spring.

FIG. 10 is a perspective view of a visor hanger.

FIG. 11 is a perspective view of the relationship between the automobile visor's transparency panel, slotted spring sleeve, support rod and bracket adaptor.

### DETAILED DESCRIPTION OF THE PREFERRED EMBODIMENT

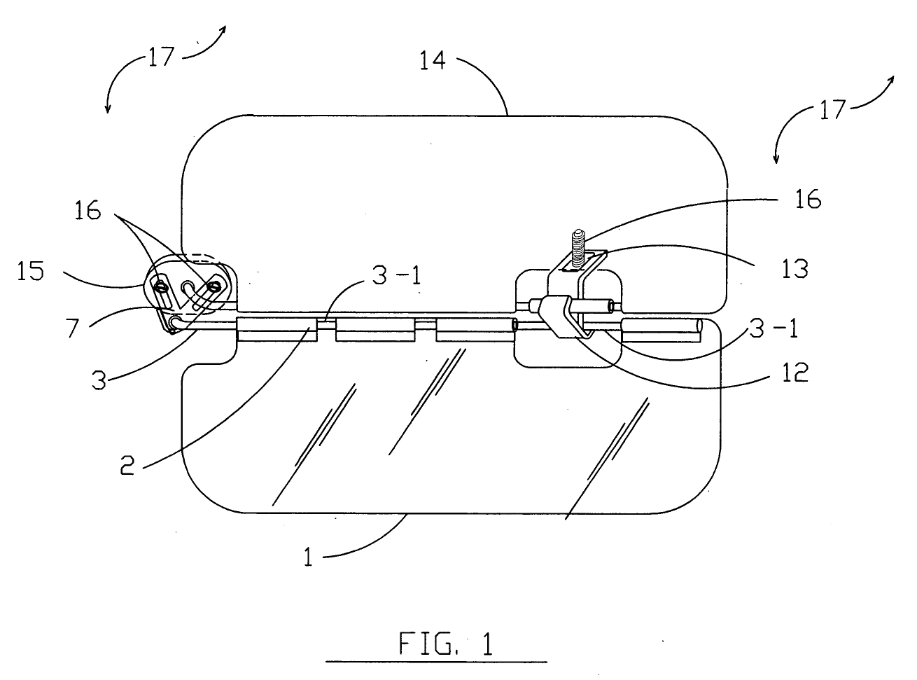

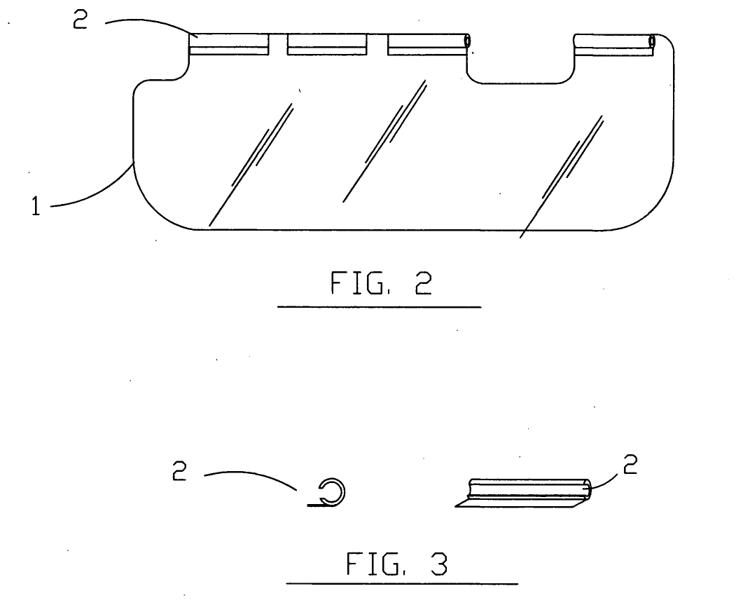

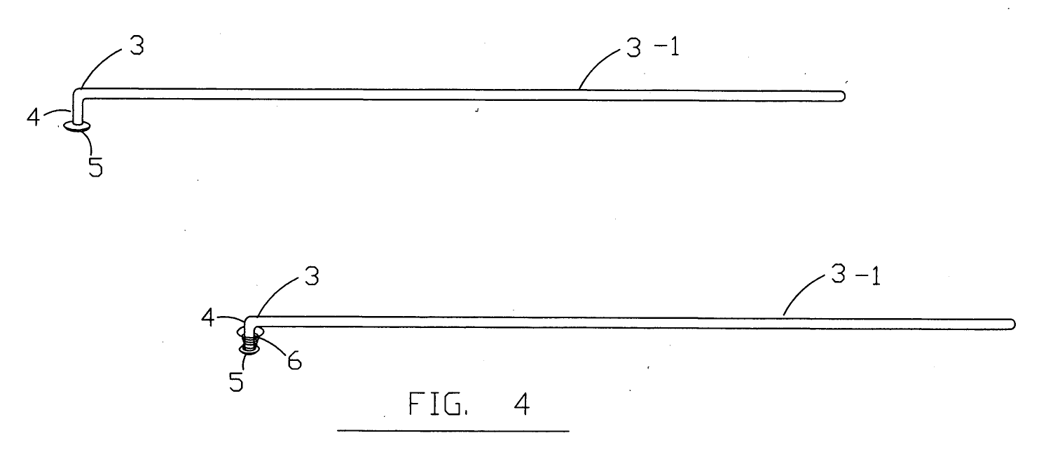

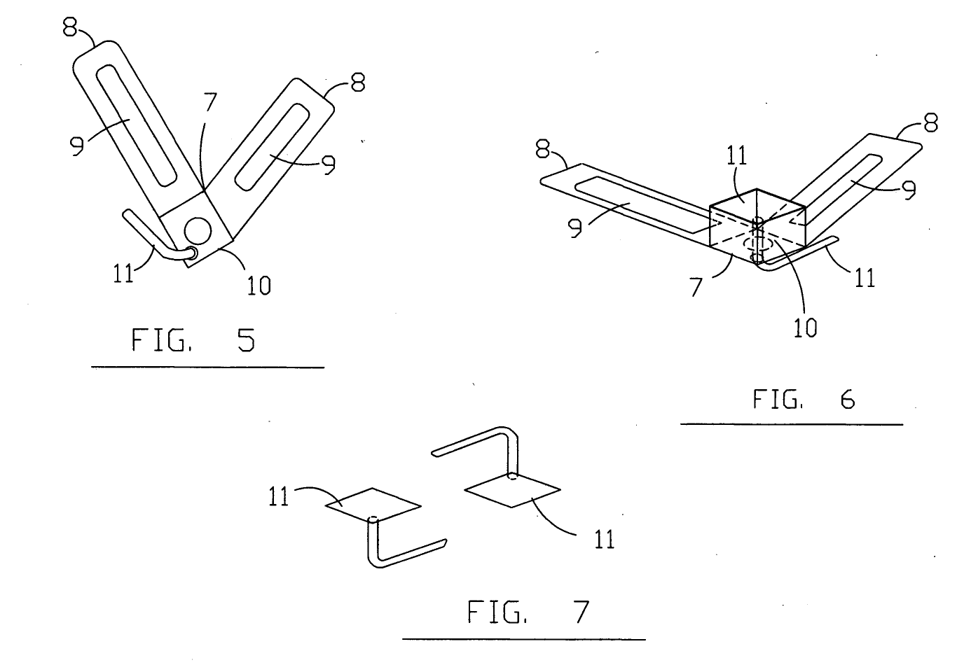

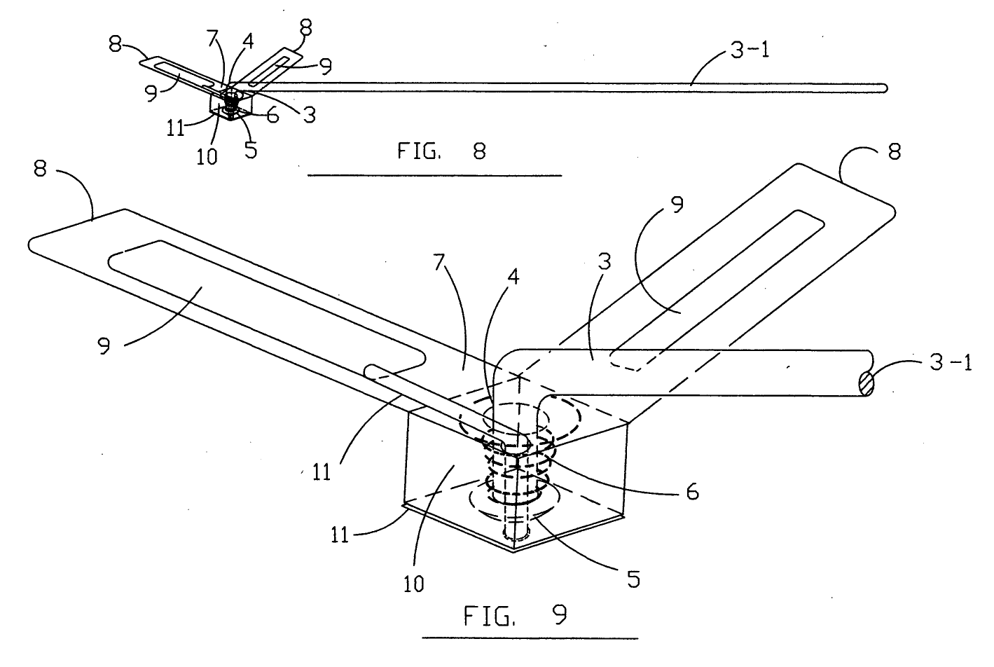

Referring now to the drawing in detail, wherein like numerals indicate like elements-throughout the several views. FIG. 1, The automobile visor properly consists of two panels. The numeral 1 designates the automobile visor light color transparency panel. The numeral 14 designates the existing original automobile visor panel. Panel 1 is longer than panel 14 to permit pulling down one or both panel at a time. Panel 1 is attached on a slotted spring sleeve 2 by a strong adhering substance such as epoxy glue see FIG. 2 and FIG. 3. The slotted spring sleeve 2 clamped at an up turned end to the automobile visor support rod 3 whereby the slotted spring sleeve 2 is held in a friction grip on the visor support rod 3 securely, yet permits the panel 1 to be operated by hand at the desired position and remain in place after that position has been determined to shield the eyes of driver and passenger from sun's rays and oncoming car's headlights. The numeral 3 designate automobile visor support rod see FIG. 4 has a short right angle bar 4 with a head 5 and attached a compression spring 6. The numeral 7 designated automobile visor mounting bracket adapter. It's fabricated into a “Y” shape. see FIG. 5, FIG. 6, FIG. 7, FIG. 8 and FIG. 9. said adapter has two flat scraper 8 both scraper have an elongated groove 9 at one end for mounting at to of existing car's visor bracket 15. and have two thread screws 16 extending through the bracket base for securement to the car 17. the automobile visor bracket adapter 7 at lower portion constituted to an open bottom box 10 and a box cover 11. box 10 their height should be half of the automobile visor support rod short right angle 4 insert the short right angle bar 4 of visor support rod into visor bracket adapter 7 from open bottom box 10 and locked it by box cover 11. automobile visor support rod 3 have longer part 3-1 which is penetration through the slotted spring sleeve 2 and hang at visor hanger 12 see FIG. 1 and FIG. 11.

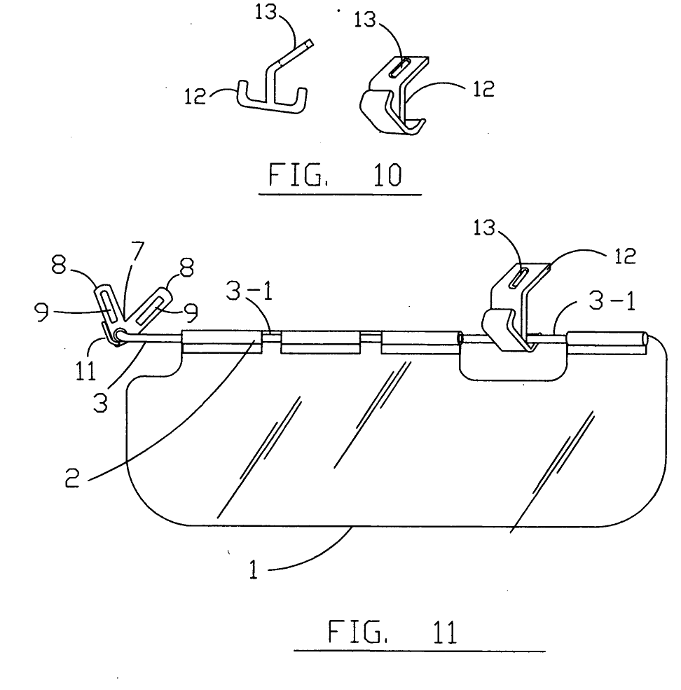

the numerals 12 designate automobile visor hanger. It assembly to an anchor shape with an elongated groove 13 see FIG. 1, FIG. 10 and FIG. 11. having a thread screw 16 extending through hanger base thereof secure to the automobile 17.

I claim:

1. Automobile driver and passenger front seat double row visor assembly comprising:
first row visor uses light color transparency panel which is attach on a slotted Spring sleeve by a strong adhering substance and clamped to an automobile visor's support rod. the slotted spring sleeve is held in a friction grip on the visor support rod securely, yet permits this light color transparency panel operated by hand to the desired position.
A visor support rod has a short right angle round head bar attached to a compression spring inserts this short right angle round head bar and compression spring at the visor bracket adapter box. this visor support rod also has a longer rod that penetrates through the slotted spring sleeve and hangs the visor on the visor hanger.
A visor bracket adapter, on one end has two flat scrapers both scrapers have an elongated groove at the center of that scraper. the other end of the visor bracket adapter fabricated an open bottom box their height should be half of the automobile visor support rod short angle round headed bar. this open box has a box cover for locked the visor support rod's short angle round headed bar and compression spring. the visor bracket adapter mounted at top of existing factory visor bracket via the visor bracket adapter's two flat scraper's elongated grooves and having two thread screws extending through bracket base for secure to the automobile.

2. The double row visor assembly of claim 1, wherein an anchor shaped visor hanger that releasable retains both visor support rod and is adapted for attachment to the automobile.

3. The double row visor assembly of claim 1, wherein the second row automobile visor is the existing factory visor. Which mounting under the first row automobile transparent light color visor panel by the existing original factory visor bracket at existing original location adjacent to the automobile windshield.
